(19) United States
(12) Patent Application Publication
(10) Pub. No.: US 2010/0065719 A1
(43) Pub. Date: Mar. 18, 2010

(54) FLEXIBLE DRYWALL MUD PAN

(76) Inventor: Jordan E. Szasz, Armada, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/233,041

(22) Filed: Sep. 18, 2008

(51) Int. Cl. B28B 7/06

(52) U.S. Cl. 249/127

(57) ABSTRACT

A flexible mud pan or trough constructed from a structurally supporting material, within which is held a volume of a viscous and settable compound. Upon setting and drying of remnants of the compound not applied, the pan is collapsed or otherwise folded/twisted, causing the flaked remnants to be forcibly disengaged from the flexible surfaces of the pan, the pan subsequently returning to a pre-existing physical configuration reconditioned for future use.

### FIELD OF THE INVENTION

A flexible mud pan, or trough, such as constructed from a natural or composite structurally supporting material, and which exhibits sufficient structural rigidity for holding a volume of a viscous and settable material. The flexible material construction permits, upon the setting and drying of remnants of the settable material which are not applied, the pan to be collapsed or otherwise twisted, thus resulting in the flaked remnants being forcibly disengaged from the flexible surfaces of the pan.

### BACKGROUND OF THE INVENTION

The existence of mudding pans or troughs is well known in the prior art, these being tools of the trade used by individuals engaged in applying drywall mud or joint compound material, such as to seams associated with aligning drywall (i.e. wallboard) sheets. Such existing of mud pans typically exhibit a three dimensional and open interior trough configuration for holding a specified volume of a viscous/flowable mudding compound.

Upon completion of a mudding application, care must be taken to quickly rinse and clean off the unused remnants, such as with water and a rag, and before the same has had an opportunity to set/dry. Failure to do so results in a dramatically greater effort which will then be required in removing the set and crusted compound. Alternatively, the pan may be ruined and must then be disposed of.

### SUMMARY OF THE INVENTION

The present invention discloses a flexible pan (or trough), and such as which is constructed from a flexible yet structurally supporting natural or composite flexible material, such as further exhibiting memory characteristics for returning to an original molded shape and following the material being deflected or otherwise manipulated. The material further preferably exhibits a Durometer rating of typically less than 100.

In another preferred variant, the flexible and structurally supporting material can further include such as a memory retaining material (such as including without limitation a polyurethane as well as neoprene or sanoprene), and which exhibits sufficient structural rigidity for holding a volume of a viscous and dryable/settable compound material, such as most typically a joint compound. The material construction is such that it permits a remnant (i.e. non-applied) portion of the joint compound to be allowed to set/dry upon the surfaces of the three dimensionally configured pan and, following that, the pan to be collapsed or otherwise folded or torsionally twisted, thus resulting in the flaked remnants being forcibly disengaged from the flexible surfaces of the pan.

Additional features associated with the present design include a plurality of removably secured and lengthwise/crosswise interconnecting extending supports, these being engaged underneath an upper perimeter edge defined lip in the tray and collectively defining a supported contact ledge associated with the upper and lip edge extending perimeter. In this fashion, the ledge provides an angled surface to the user and from which it is desirable to trim or otherwise reshape a portion of the mud/compound retrieved by the applying blade, this prior to applying to the wallboard surface or seam.

### BRIEF DESCRIPTION OF THE DRAWINGS

Reference will flow be made to the attached drawings, when read in combination with the following detailed description, wherein like reference numerals refer to lice parts throughout the several views, and in which:

FIG. 1 is a perspective view of The mud pan according to a preferred embodiment of the present inventions;

FIG. 2 is a rotated and underside perspective of the mud pan shown in FIG. 1;

FIG. 3 is a lengthwise cutaway view of the mud pan shown in FIG. 1;

FIG. 4 is an exploded perspective of the mud pan, such as shown in FIG. 2, and further illustrating the plurality of removably secured and lengthwise/crosswise interconnecting extending supports, these being engaged underneath and upper perimeter edge defined lip in the tray and collectively defining a supported contact ledge associated with the upper and lip edge extending perimeter;

FIG. 5 is an enlarged partial view of a selected lengthwise cutaway location of the upper lip edge, and within which is seated a cross wise configured and elongate extending support; and

FIG. 6 is an environmental perspective showing the pan being collapsed, such as by folding or torsionally twisting, thus resulting in the flaked remnants being forcibly disengaged from the flexible surfaces of the pan.

### DETAILED DESCRIPTION OF THE PREFERRED EMBODIMENTS

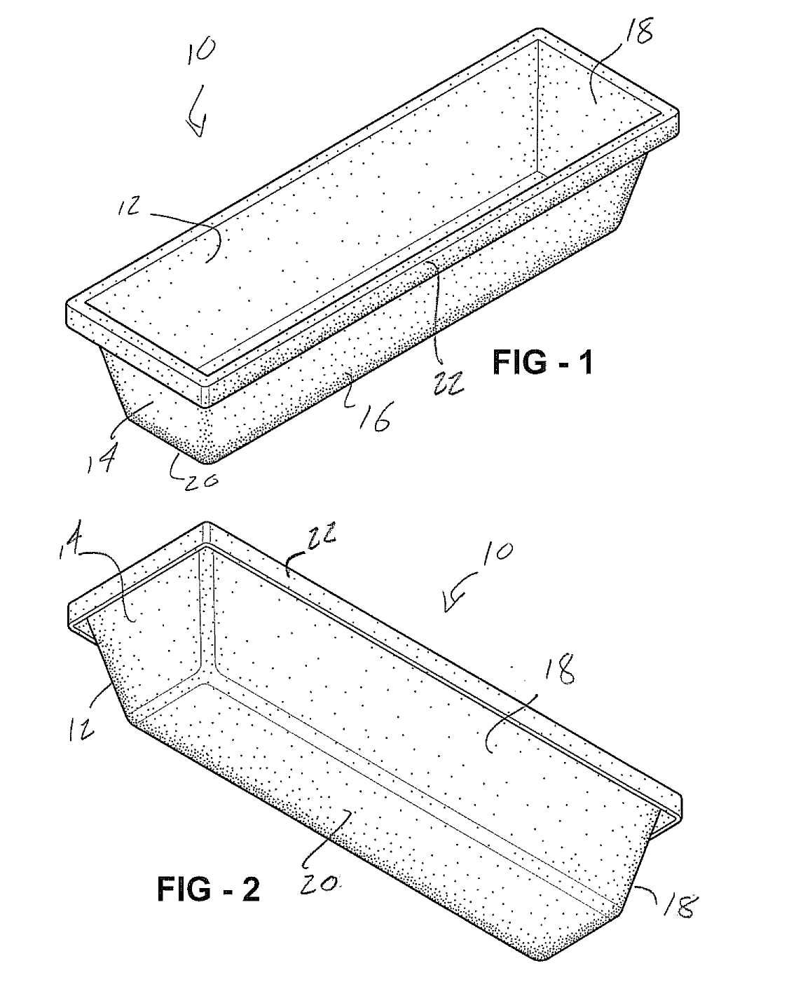

Referring now to FIGS. 1 and 2, a pair of upper and underside rotated perspective views are each shown at 10 of a mud pan according to one non-limiting preferred embodiment of the present inventions. While not limited to any one shape or configuration, the pan 10 (also known as a trough) is illustrated as an open three dimensional structure, this including any plurality of sides, such as four interconnected sides at 12, 14, 16 and 18. The interconnected sides are upwardly/outwardly angled in the illustrated embodiment extend from a bottom 20 to an upper and perimeter extending lip edge, further collectively defined around its entire perimeter as lip 22. Having illustrated the pan 10 in one desired configuration, it is also envisioned and understood that the shaping or configuration of the pan is entirely subject to change or modification, and can also include such as a rounded bottom, as well as other polygonal or multi-sided configurations, such as including pentangular, hexagonal, octagonal, round (this exhibiting an infinite number of sides).

As previously described, the present invention discloses a flexible mud pan (or trough), and such as which is constructed from a flexible yet structurally supporting natural or composite material having memory retention properties and with a Durometer rating of less than 100. In one non-limiting preferred application, the memory retaining material can include a durable foam (such as including without limitation any type of polymeric or polyurethane material, further including without limitation a neoprene or sanoprene) material, and which exhibits sufficient structural rigidity for holding a volume of a viscous and settable/curable material (e.g. such as a joint compound).

The structurally supporting material construction permits a remnant of the viscous settable material/joint compound to be allowed to set/dry within the pan and, following that, the pan to be collapsed or otherwise folded or torsionally twisted, thus resulting in the flaked remnants being forcibly disengaged from the flexibly displacing surfaces of the pan.

Durometer hardness, like many other hardness tests, measures the depth of an indentation in the material created by a given force on a standardized presser foot. This depth is dependent on the hardness of the material, its viscoelastic properties, the shape of the presser foot, and the duration of the test. ASTM D2240 durometers allows for a measurement of the initial hardness, or the indentation hardness after a given period of time. The basic test requires applying the force in a consistent manner, without shock measuring the hardness (depth of the indentation). If a timed hardness is desired, force is applied for the required time and then read. The material under test should be a minimum of 6.4 nm (0.25 inch) thick. The final value of the hardness depends on the depth of the indenter's penetration. If the indenter penetrates 2.5 mm or more into the material, the durometer is 0 for that scale. If it does not penetrate at all, then the durometer is 100 for that scale. It is for this reason that multiple scales exist. Durometer is a dimensionless quantity, and there is no simple relationship between a material's durometer in one scale, and its durometer in any other scale, or by any other hardness test.

As is also known, candidate materials such as Neoprene or polychloroprene belong to a family of synthetic rubbers that are produced by polymerization of chloreprene. Such materials are known for use in a wide variety of other environments, such as in wetsuits, laptop sleeves, electrical insulation, and car fan belts. Neoprene is the DuPont Performance Elastomers trade name. Other memory/structurally retaining foam materials are further made from polyurethane with additional chemicals that increase its viscosity level, thereby increasing its density. It is envisioned and understood that the tray or pan construction according to the present inventions can be constructed from any of a plurality of different, or selectively intermixed, materials so as to exhibit the necessary properties of structural supporting stability, such as when filled with a volume of a joint compound, as well as the ability to be collapsed or otherwise forcibly displaced and subsequently returned to its original shape.

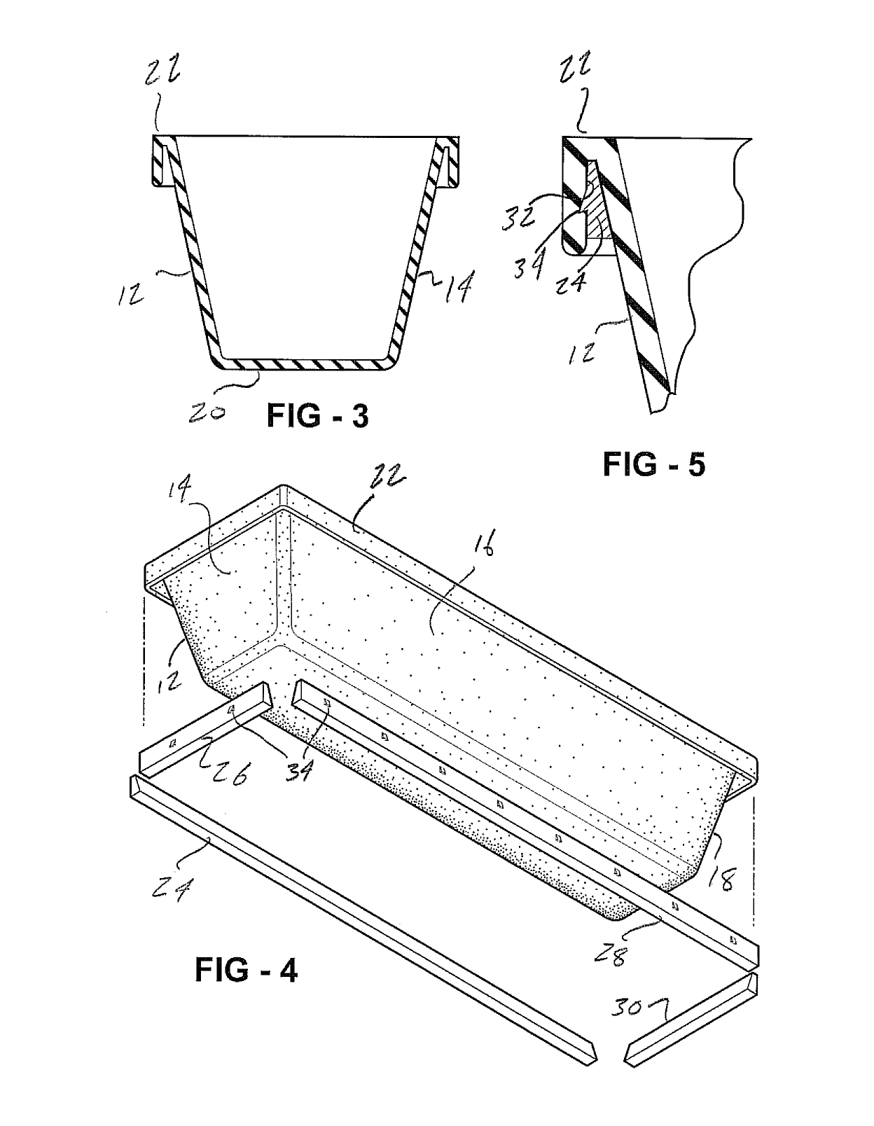

Referring further to FIG. 3, a lengthwise cutaway view is shown of the mud pan 10 in FIGS. 1 and 2. Also shown in FIG. 4 is an exploded perspective of the mud pan 10, such as shown in FIG. 2, and further illustrating an optionally provided plurality of removably secured and lengthwise/crosswise end to end connecting supports, as shown at 24, 26, 28 and 30 in corresponding fashion to sides 12, 14,16 and 18.

The supports each correspond in overall length to a given side or interconnecting end dimension such that, upon assembly, each are engaged underneath a fold 32 (see FIG. 5) defined in the inside of the perimeter extending lip 22. As illustrated, each of the supports can exhibit a flared or angled cross sectional profile, as again shown in FIG. 5, and in order to conform the fold configuration associated with the downward fold 32 of the lip 22. Also shown in each of FIGS. 4 and 5 are angled prongs 34, these being arranged in spaced apart and downwardly directed fashion along the exterior surface associated with each of the supports and. Upon being inserted within the underside fold 32 of the lip 22, each of the perimeter defining supports 24-30 are retained in place by the gripping action of the prongs 34 exerted against the inside face of the folded portion 32.

The supports 24-30 are further each constructed of a rigid material not limited to a durable aluminum, nylon, or other synthetic material and such that, in use, the supports are engaged underneath the fold 32 in the upper perimeter edge defined lip 22. The supports are installed to collectively define a supported contact ledge associated with the upper and lip edge extending perimeter. In this fashion, the ledge provides an angled surface to the user and from which it is desirable to trim or otherwise reshape a portion of the mud/compound retrieved by the applying blade (not shape), this such as prior to applying the compound to the wallboard surface or seam.

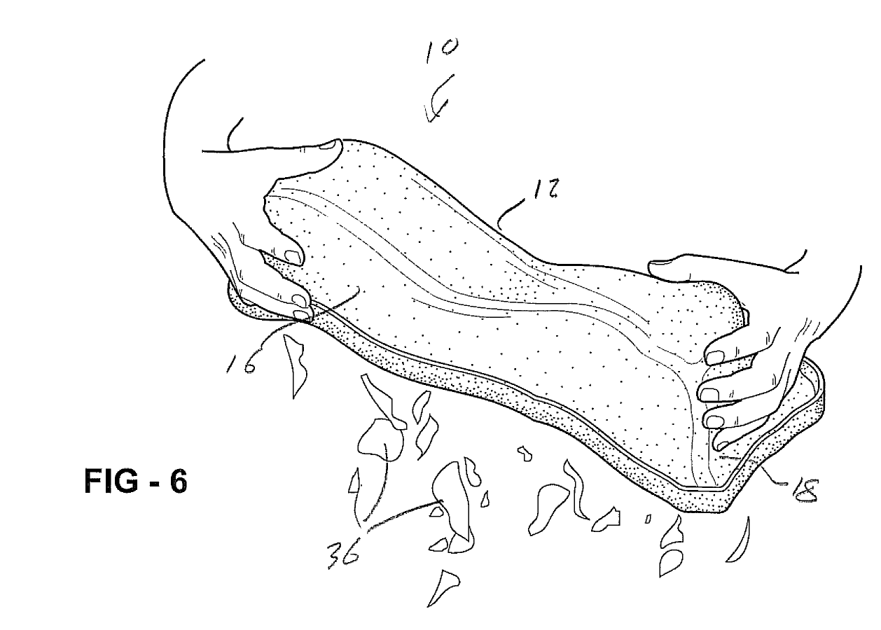

Finally, and referring to FIG. 6, an environmental perspective is shown of the pan 10 being collapsed, such as by folding or torsionally twisting, thus resulting in flaked remnants 36 being forcibly disengaged from the various flexible surfaces of the pan 10. Prior to forcible dislodgement of the dried compound remnants, the rigid lip edge supports 24-30 are removed.

It is also understood that the mud pan 10 can operate without any rigid inserts or supports. In this fashion, novel mud pan design can be left after use to allow any remaining volume of unapplied joint compound to set and dry, following which the resultant flaked remnants can be quickly and effectively removed, without the need of scraping and/or the use of water or other fluid based cleaning solutions. It is also understood that the degree of structural rigidity associated with the memory foam structure can be manipulated or otherwise modified, based upon the load carrying requirements of the associated joint compound.

Having described my invention, other and additional preferred embodiments will become apparent to those skilled in the art to which it pertains, and without deviating from the scope of the appended claims.

I claim.

1. A container for holding a volume of a settable material, comprising:
a body having a bottom and interconnected sides; and
said body being constructed from a flexible and structurally supporting material which, upon any remainder of the settable compound drying into flakes, permitting said bottom and sides to be forcibly deflected relative one another in order to forcibly disengage the flakes, said body subsequently reverting to a shape exhibited prior to said sides and bottom being forcibly deflected.

2. The container as described in claim 1, said body further comprising four interconnecting sides surrounding said bottom.

3. The container as described in claim 2, each of said interconnecting sides further comprising a folded over portion defining an upper lip.

4. The container as described in claim 3, further comprising a plurality of removably secured and end to end connecting rigid supports engaged underneath said folded over portion associated with said upper lip, said supports collectively defining a contact ledge.

5. The container as described in claim 4, each of said supports further comprising angled prongs arranged in spaced apart and downwardly directed fashion along an exterior surface associated with each of said supports, said prongs gripping against each of said folded over portions.

6. The container as described in claim 1, said body having a specified shape and size and further comprising at least one selected from the group including natural and composite materials exhibiting a Durometer rating of less than 100.

7. The container as described in claim 6, said body having a specified shape and size and being constructed from any of the group including polymeric or polyurethane materials.

8. The container as described in claim 7, said body further comprising at least one of a neoprene or a sanoprene material.

9. A flexible drywall mud pan, comprising:
a body having a bottom and four upwardly angled and interconnected sides, said body being constructed from a flexible and structurally supporting material;
each of said interconnecting sides further comprising a folded over portion defining an upper lip; and
upon a viscous and settable compound contained within said body drying into flakes, said bottom and sides being forcibly deflected relative one another in order to forcibly disengage the flakes from surfaces associated with said body, said body subsequently reverting to a shape exhibited prior to said sides and bottom being forcibly deflected.

10. The container as described in claim 9, further comprising a plurality of removably secured and end to end connecting rigid supports engaged underneath said folded over portion associated with said upper lip, said supports collectively defining a contact ledge.

11. The container as described in claim 10, each of said supports further comprising angled prongs arranged in spaced apart and downwardly directed fashion along an exterior surface associated with each of said supports, said prongs gripping against each of said folded over portions.

12. The container as described in claim 9, said body having a specified shape and size and further comprising at least one selected from the group including natural and composite materials exhibiting a Durometer rating of less than 100.

13. The container as described in claim 12, said body having a specified shape and size and being constructed from any of the group including polymeric or polyurethane materials.

14. The container as described in claim 13, said body further comprising at least one of a neoprene or a sanoprene material.

15. A flexible drywall mud pan, comprising:
a body having a bottom and four upwardly angled and interconnected sides, said body being constructed from a flexible and structurally supporting memory foam;
each of said interconnecting sides further comprising a folded over portion defining an upper lip;
a plurality of removably secured and end to end connecting rigid supports engaged underneath said folded over portion associated with said upper lip, said supports collectively defining a contact ledge; and
upon a wallboard compound contained within said body drying into flakes, said bottom and sides being forcibly deflected relative one another in order to forcibly disengage the flakes from surfaces associated with said body, said body subsequently reverting to a shape exhibited prior to said sides and bottom being forcibly deflected.
